(19) United States
(12) Patent Application Publication
(10) Pub. No.: US 2009/0076913 A1
(43) Pub. Date: Mar. 19, 2009

(54) Method for Obtaining Biodiesel, Alternative Fuels and Renewable Fuels Tax Credits and Treatment

(75) Inventor: William Douglas Morgan, Richmond, CA (US)

Correspondence Address: KING & SPALDING, LLP, 1100 LOUISIANA ST., STE. 4000, ATTN.: IP Docketing, HOUSTON, TX, 77002-5213, US

(73) Assignee: Endicott Biofuels II, LLC, Houston, TX (US)

(21) Appl. No.: 12/174,392

(22) Filed: Jul. 16, 2008

Related U.S. Application Data
(60) Provisional application No. 60/973,726, filed on Sep. 19, 2007.

(51) Int. Cl. G06Q 30/00

(52) U.S. Cl. 705/14

(57) ABSTRACT

The present invention relates to a method of obtaining U.S. Federal and State tax credits, U.S. Federal renewable fuel treatment, and other incentives by production of esters manufactured by the esterification of carboxylic acids using slurry phase, heterogeneous catalyzed, reactive distillation, and sale thereof for U.S. consumption as a renewable fuel.

This application claims priority under 35 U.S.C. 119(e) to U.S. provisional application 60/973,726, filed Sep. 19, 2007, the contents of which are incorporated by reference in their entirety.

### FIELD OF INVENTION

The present invention relates to a method of obtaining U.S. Federal and State tax credits, U.S. Federal renewable fuel treatment, and other incentives by production of esters manufactured by the esterification of carboxylic acids using slurry phase, heterogeneous catalyzed, reactive distillation, and sale thereof for U.S. consumption as a renewable fuel.

### BACKGROUND

Diesel fuel is a refined petroleum product which is burned in the engines powering most of the world's trains, ships, and large trucks. Petroleum is a non-renewable resource of finite supply. Acute shortages and dramatic price increases in petroleum and the refined products derived from petroleum have been suffered by industrialized countries during the past quarter-century. Furthermore, diesel engines which run on petroleum based diesel emit relatively high levels of certain pollutants, especially particulates. Accordingly, research effort is now being directed toward replacing some or all petroleum-based diesel fuel with a cleaner-burning fuel derived from renewable sources such as farm crops, agricultural waste streams or municipal or other waste streams.

In an effort to partially replace dependence on petroleum-based diesel, vegetable oils have been directly added to diesel fuel. These vegetable oils are composed mainly of triglycerides, and often contain small amounts (typically between 1 and 10% by weight) of free fatty acids. Some vegetable oils may also contain small amounts (typically less than a few percent by weight) of mono- and di-glycerides.

Triglycerides are esters of glycerol, CH₂(OH)CH(OH)CH₂(OH), and three fatty acids. Fatty acids are, in turn, aliphatic compounds containing 4 to 24 carbon atoms and having a terminal carboxyl group. Diglycerides are esters of glycerol and two fatty acids, and monoglycerides are esters of glycerol and one fatty acid. Naturally occurring fatty acids, with only minor exceptions, have an even number of carbon atoms and, if any unsaturation is present, the first double bond is generally located between the ninth and tenth carbon atoms. The characteristics of the triglyceride are influenced by the nature of their fatty acid residues.

The production of alkyl esters from glycerides by transesterification is a known process. However, transesterification suffers in that the reaction generally requires the addition of an acid or base catalyst which must be neutralized after the reaction, thereby generating salts and soaps. In addition, while transesterification results in the separation of fatty acid esters from triglycerides, it also results in the production of glycerin, which must then be separated from the fatty acid esters, excess alcohol, salts, and soaps. Furthermore, the use of a strong acid, such as sulfuric acid, typically leads to higher sulfur content in the resulting biodiesel as the acid reacts with the double bonds in the fatty acid chains.

In an effort to overcome some of the problems associated with transesterification, several attempts have been made to employ esterification between fatty acids and alcohols. In these processes fatty acids are prepared from triglycerides by hydrolysis, followed by catalyzed esterification of the fatty acids with an alcohol, preferably methanol. While this procedure is practiced in the production of fatty alcohols and fatty acid esters, as described in U.S. Pat. No. 5,536,856 (Harrison et al.), it has not been practiced in the production of biodiesel fuel.

Despite any research that may now be directed toward replacing some or all petroleum-based diesel fuel with a cleaner-burning fuel derived from a renewable source such as farm crops, processes for producing renewable fuels as an alternative to petroleum products have not had economic success. As a result, both federal and state governments in the United States have created economic incentives for alternative fuels. However, for any original process in development, there may be no information as to the incentives and credits for which the process may be eligible. Thus, there is a need for methods of obtaining economic incentives and tax credits for original processes, particularly in relation to the alternative fuel industry.

### SUMMARY OF INVENTION

The present invention provides for the use of heterogeneous, slurry phase, reactive distillation to convert carboxylic acids to esters. In a preferred embodiment, the present invention employs reactive distillation as a method to assist in the production of biodiesel fuel having low glycerin, water and sulfur content. Reactive distillation is a method wherein specific reactions are driven forward despite an unfavorable equilibrium position for the main reaction, where the driving force during the reaction is the continuous removal of one or more substances from the reaction mixture. By removal of one or more products, the reaction equilibrium may become favorable. Sulfur content is reduced by employing reactive distillation over a solid catalyst bed and free glycerin concentration is reduced by employing fat hydrolysis.

While the present invention is a technical advance over the prior art, various marketplace factors may interfere with the widespread adoption of the present invention. Therefore, the present invention also provides methods for obtaining Federal and State Tax Credits and other incentives for the production of biodiesel and alternative ester-based fuels. In a preferred embodiment, the disclosed process for production of ester-based fuels is coupled with the methods of obtaining credits and incentives in order to provide cost advantages over the prior art.

According to one aspect of the present invention, carboxylic acids suitable for further conversion to fuel esters, the use of which can further generate tax credits and other incentives, are obtained by hydrolysis of glycerides, by distillation from mixtures of fatty acids and glycerides, or by acidulation of carboxylic acid soaps. The fatty acids are then transformed to biodiesel by reaction of a fatty acid component and an alcohol component, in which the fatty acid component and alcohol component are passed in countercurrent relation through an esterification zone maintained under esterification conditions and containing a solid esterification catalyst. In certain embodiments, the esterification catalyst may be selected from particulate ion exchange resins having sulfonic acid groups, carboxylic acid groups or both. The process is characterized in that the esterification zone includes a column reactor provided with a plurality of esterification trays mounted one above another, each adapted to hold a predetermined liquid volume and a charge of solid esterification catalyst. The less volatile component of the fatty acid component and of the alcohol component is supplied in liquid phase to the uppermost section of the reaction column and the more volatile component is supplied as a vapor to a lower portion of the reaction column. Vapor comprising the more volatile component and water from the esterification can be recovered from an upper part of the column reactor, and the biodiesel can be recovered from a lower part of the column reactor.

In another embodiment, a process for the preparation of biodiesel from a fatty acid feedstock is provided. A methanol vapor feedstream and a fatty acid feedstream are continuously introduced to a reaction vessel. The methanol and fatty acid are catalytically reacted in a reaction zone in the presence of a heterogeneous esterification catalyst within the reaction vessel to produce fatty acid methyl esters and water. The water is removed from the reaction zone with the methanol vapor and is separated from the alcohol, and the biodiesel is collected as the bottoms product.

In another embodiment, a process for preparing a biodiesel fuel from a triglyceride feedstock, wherein the biodiesel has a low glycerin and sulfur content is provided. The triglyceride feedstock is introduced into a fat splitter to produce a fatty acid-rich feedstream, which can be continuously fed to a reaction vessel. Similarly, an alcohol vapor feedstream is introduced to the reaction column. The fatty acid feedstream and alcohol feedstream catalytically react as they pass countercurrently among the equilibrium stages that hold a solid catalyst to produce biodiesel and water. Water is stripped from the reaction vessel along with alcohol vapor due to the action of the equilibrium stages, separated from the alcohol in an additional step and the alcohol is recycled to the reaction vessel. In one embodiment, the catalytic zone includes an ion exchange resin catalyst comprising —SO₃H or —CO₂H functional groups.

In another embodiment, a biodiesel fuel is prepared having water content less than 0.050% by volume. In another embodiment, the biodiesel fuel has a kinematic viscosity that is between 1.9 and 6 mm²/s. In another embodiment, the biodiesel fuel has a sulfur content that is less than 500 ppm, preferably less than 15 ppm. In another embodiment, the free glycerin content of the biodiesel fuel is less than 0.020% by weight. In another embodiment, the total glycerin content of the biodiesel is less than 0.240% by weight.

In another embodiment, biodiesel prepared by the methods of this invention are further employed to obtain tax credits, production incentives, renewable fuel treatment or all three. In one embodiment, esters that meet IRC's definition of Agri-Biodiesel are prepared from fatty acids according to the methods of the invention. These esters are then blended with 0.1 to 99.9% taxable diesel (as defined by IRC) prior to sale to a third party for use as or used by the producing taxpayer for fuel. In doing this, $1.00 per gallon in refundable tax credits under IRC Section 6426 are obtained from the Federal Government, if available. Depending on the state where the material is produced, state incentives are also obtained.

In another embodiment, esters meeting IRC's definition of biodiesel are produced, blended according to 6426 rules, and then sold to a third party for use as or used by the producing taxpayer for fuel and $0.50 per gallon in refundable Federal tax credits are obtained, if available. Depending on the state where material is produced, state incentives are also obtained.

In another embodiment, esters that fail to meet IRC's definition of Agri-biodiesel or biodiesel but which meet ASTM specifications for other fuels are blended with taxable fuel and sold for use as a fuel or used by the producing taxpayer in order to generate $0.50 in refundable Federal tax credits under Section 6426, if available, along with any additional state incentives.

In another embodiment, application is made to EPA for registration of esters that otherwise fail to meet IRC's definition of Agri-biodiesel or biodiesel but which meet ASTM specifications for other fuels. Once registration is obtained, these non-biodiesel esters are blended with taxable fuel and sold for use as a fuel or used by the producing taxpayer in order to generate $1.00 in non-refundable Federal tax credits under Section 40A, if available, along with any additional state incentives.

In another embodiment, the producers maintain qualification as a small agri-biodiesel producer such that the methods of the invention permit claiming of small agri-biodiesel producer credits from the federal government.

In another embodiment of the invention, esters meeting the definition of biodiesel and/or Agri-biodiesel are used by the taxpaying producer or placed directly in the fuel tank of a user at retail without blending with other taxable fuel. In doing so, non-refundable Federal Tax credits of $0.50 for biodiesel and/or $1.00 per gallon for Agri-biodiesel are generated under Section 40A, if available, along with any applicable state credits and/or incentives.

In another embodiment of the invention, by-products from the method of the invention such as distillation bottoms are blended with taxable fuel and sold to third parties for use as or used by the producing taxpayer as fuel. In doing so, $0.50 in refundable Federal Tax Credits are obtained under Section 6426, if available, along with any other applicable Federal and state credits or incentives.

In yet another embodiment of the invention, application is made to the EPA for registration of esters that meet the definition of Advanced Biofuel or Biomass-based Diesel as appropriate according to the Energy Independence and Security Act of 2007, Section 211. In doing so, these esters will meet the statutory definition of renewable fuel according to the EPA Regulation of Fuels and Fuel Additives: Renewable Fuel Standard Program and these esters will then be assigned a Renewable Identification Number (RIN).

### BRIEF DESCRIPTION OF THE DRAWINGS

FIG. 1 shows one embodiment of the present reaction for the preparation of fatty acid esters via heterogeneous, slurry phase reactive distillation.

FIG. 2 shows another embodiment of the present invention for the preparation of fatty acid esters, include a separation step for the ester product.

FIG. 3 shows another embodiment of the present invention, further including a pre-esterification process.

FIG. 4 shows another embodiment of the present invention, further providing a settling tank.

FIG. 5 shows another embodiment of the present invention, further including a reaction vessel for the preparation of a fatty acid ester and ether additive.

FIG. 6 shows another embodiment of the present invention, further including a fat splitter.

### DETAILED DESCRIPTION

The present invention relates to a method of obtaining U.S. Federal and State tax credits, renewable fuel treatment and other incentives via the production of ester fuels.

### Obtaining Tax Credits or Other Production Incentives

In the U.S., federal and state tax credits as well as producer incentive payments can be obtained for the production and sale of “Biodiesel” (also known as biodiesel) hereinafter defined as monoalkyl esters of long chain fatty acids derived from plant or animal matter which meet (A) the registration requirements for fuels and fuel additives established by the Environmental Protection Agency under section 211 of the Clean Air Act (42 U.S.C. 7545), and as amended by the Energy Independence and Security Act of 2007 and (B) the requirements of the American

### Society of Testing and Materials D6751.

Tax credits for the production of and sale of ester-based fuels are provided under three sections of Internal Revenue Code (IRC) (U.S. Code of Federal Regulations Title 26). Section 40A provides non-refundable credits for the use or sale of pure esters meeting the above specifications and registration requirements. IRC Section 40A provides refundable tax credits for “Biodiesel” of $0.50 per gallon for general biodiesel. Section 40A also provides refundable credits of $1.00 per gallon for Agri-biodiesel hereinafter defined as biodiesel derived solely from virgin oils, including esters derived from virgin vegetable oils from corn, soybeans, sunflower seeds, cottonseeds, canola, crambe, rapeseeds, safflowers, flaxseeds, rice bran, and mustard seeds, and from animal fats. IRC Section 40A also provides $0.10 per gallon of small producers credits for qualified small producers of Agri-biodiesel where qualified small producers are defined by the code.

IRC Section 6426 provides refundable credits of $0.50 per gallon for general biodiesel and $1.00 per gallon for Agri-biodiesel mixtures for sale or use in a trade or business of the taxpayer. The term “Biodiesel mixture” is further qualified as:
a mixture of Biodiesel and diesel fuel (as defined in section 4083(a)(3)), determined without regard to any use of kerosene, which
(A) is sold by the taxpayer producing such mixture to any person for use as a fuel, or
(B) is used as a fuel by the taxpayer producing such mixture.
   IRC Section 6426 also provides refundable tax credits of $0.50 per gallon for liquid hydrocarbons, other than ethanol, methanol, or biodiesel, derived from biomass that are used as a fuel in a motorboat or motor vehicle. Section 6426 also provides refundable credits of $0.50 per gallon for mixtures of alternative fuels with taxable fuel that are sold or used as fuel by the taxpayer.

Section 211 of the Clean Air Act (42 U.S.C. 7545), as amended by the Energy Independence and Security Act of 2007 provides for the treatment of advanced biofuels and biomass-based diesel (both considered “biodiesel” for purposes of this document) as a qualifying fuel under the EPA Renewable Fuel Standard Program, and the registration thereof resulting in the creation of renewable identification numbers (RINs) for every 1,000 gallons produced.

Several state legislatures have also weighed in with various tax credits and other incentives that relate back to the Biodiesel and Alternative Fuel definitions promulgated by IRC, as summarized in Table 1:

| | | FLEET | |
|---|---|---|---|
| | TAX CREDITS/REBATES/GRANTS | CREDITS | FEDERAL/STATE MANDATES |
| Alaska | | | Department of Transportation (DOT) is required to |
| | | | consider using alternative fuels for automotive purposes |
| | | | whenever practicable. DOT may participate in joint |
| | | | ventures with public or private partners that will foster |
| | | | the availability of alternative fuel for all consumers of |
| | | | automobile fuel. |
| Arizona | | Local governments | New motor vehicle dealers are required to make |
| | | in areas of | information on AFVs and incentives in Arizona for |
| | | Maricopa, Pinal, | purchasing or leasing AFVs available to the public |
| | | Yavapai, and Pima | Biodiesel for sale must meet the ASTM specifications |
| | | counties are | D6751. Blends of Biodiesel sold must meet the D975 |
| | | required to develop | specifications. |
| | | and implement a | |
| | | vehicle fleet plan | |
| | | for the purpose of | |
| | | encouraging and | |
| | | increasing the use | |
| | | of alternative fuels. | |
| Arkansas | Alternative Fuel Commission may | | |
| | provide grants of up to $0.10 per gallon | | |
| | for production of biodiesel up to 5 | | |
| | million gallons per producer, per year, | | |
| | not to exceed 5 years | | |
| | Income tax credit of up to 5% of the | | |
| | costs of facilities and equipment used in | | |
| | wholesale or retail distribution of | | |
| | biodiesel fuels | | |
| | $0.50 tax refund per gallon of biodiesel | | |
| | fuel used to produce a biodiesel mixture | | |
| | that contains not more than 2% and is for | | |
| | sale by the supplier for use by the | | |
| | supplier in trade or business | | |
| California | Lower-Emission School Bus Program | | SCAQMD can require government fleets and private |
| | Grants for school districts to obtain | | contractors under contract with public entities to |
| | buses which are lower-emitting | | purchase cleaner, alternative fuel vehicles. Rules are |
| | alternative fuel or diesel models and to | | applicable in Los Angeles; San Bernardino, Riverside |
| | retrofit in-use diesel buses with emission | | and Orange Counties. |
| | control devices CARB/CEC directed to | | Every city, county and special district, including school |
| | develop a plan allocating $25 million in | | districts and community colleges can require that 75% of |
| | incentives for among other things, | | the passenger cars and/or light duty trucks acquired be |
| | construction of retail fleet refueling | | energy-efficient vehicles. |
| | stations and for alternate fuel production | | The SJVAPCD is authorized to adopt regulations that |
| | in California. | | promote the use of alternative fuels and require the use |
| | The CMMAQSAP provides incentive | | of best pollution control technology for new and |
| | based funding for incremental cost of | | modified sources of pollution. They may establish |
| | purchasing cleaner than required engines | | expedited permit review and assistance for facilities |
| | and equipment. Eligible products | | projects that are directly related to the use of clean fuel |
| | include: on-road, off-road, marine, | | vehicle technologies. |
| | locomotive, agricultural engines, | | E85 fuel must meet the ASTM International |
| | forklifts, airport ground support | | specifications. |
| | equipment, auxiliary power units, heavy- | | Diesel fuel used for blending must meet the ASTM |
| | duty fleet modernization projects, | | International specifications. |
| | projects for cars & light-duty trucks. | | Blending stock must meet the ASTM International |
| | In San Joaquin Valley the REMOVE II | | specifications. |
| | program provides incentives for the | | Finished biodiesel blend must meet the ASTM |
| | purchase of low-emissions passenger | | International specifications. |
| | vehicles, light trucks, small buses and | | |
| | trucks under 14,000 pounds GVWR. | | |
| | The AB2766 program provides | | |
| | grants/loans to projects that reduce | | |
| | on/off road emissions. Funds may be | | |
| | used to purchase AFV vehicles and | | |
| | building alternative fuel and technology | | |
| | infrastructure | | |
| Colorado | Tax credit issued (years prior to 2011) | | By Jan. 01, 2007, The Executive Director of State personnel |
| | for actual costs of construction, | | must adopt a policy that requires all state-owned diesel |
| | reconstruction, or acquisition of an | | vehicles and equipment to be fueled with B20 biodiesel |
| | alternate fuel refueling facility | | blend. |
| | attributable to storage, compression, | | |
| | charging or dispensing of alternative | | |
| | fuels. | | |
| | CDR rebate available for the purchase of | | |
| | an AFV or conversion of an existing | | |
| | vehicle if owned by the State of | | |
| | Colorado, a political subdivision of the | | |
| | state or a tax-exempt organization and | | |
| | used in connection with the official | | |
| | activities of the entity | | |
| Connecticut | | AFVs purchased | |
| | | for state fleet to | |
| | | meet State Agency | |
| | | Emission | |
| | | Reduction policies | |
| | | must be able to use | |
| | | alternative fuel that | |
| | | is available within | |
| | | the state. | |
| Delaware | Green Energy Fund grants for the | | |
| | development, promotion and support of | | |
| | energy efficiency programs including | | |
| | biodiesel manufacturing facilities. | | |
| | Waiving of taxes on alternative fuels | | |
| | used in official vehicles for the U.S. or | | |
| | any governmental agency, including | | |
| | state agencies and volunteer fire and | | |
| | rescue companies. | | |
| | The DSB offers rebates and marketing, | | |
| | promotion, and education assistance for | | |
| | biodiesel use on a case-by-case basis. | | |
| District of | | Fleet operators | |
| Columbia | | who control at | |
| | | least 10 clean fuel | |
| | | vehicles in an | |
| | | ozone non- | |
| | | attainment area, | |
| | | are exempt from | |
| | | time-of-day, day- | |
| | | of-week | |
| | | restrictions and | |
| | | commercial | |
| | | vehicle bans. | |
| Florida | Exemption from state sales, rental, use, | State and Local | |
| | consumption, distribution and storage | Government AFV | |
| | tax on materials used in the distribution | fleet vehicles are | |
| | of biodiesel and ethanol, including | exempt from | |
| | refueling infrastructure, transportation, | purchasing the | |
| | and storage up to a maximum of $1 | state decal required | |
| | million in taxes each year for all | in lieu of excise | |
| | taxpayers. | tax on gasoline. | |
| | A state sales tax credit for costs incurred | | |
| | between Jul. 1, 2006 and Jun. 30, 2010 | | |
| | for 75% of all capital costs, operation | | |
| | and distribution of biodiesel and ethanol | | |
| | in the state | | |
| Georgia | | | Biodiesel produced or sold, including use for blending, |
| | | | must meet the ASTM standard D 6751. |
| Hawaii | Taxpayers making a high technology | State agencies | Contracts for the purchase of diesel fuel are to be |
| | business investment for which 75% o of | must purchase | awarded with preference given to bids for biofuels or |
| | the income (in state only) is related to | alternative fuels | blends of biofuel and petroleum fuel. The alternative |
| | research pertaining to non-fossil fuel | and ethanol | fuel standard will be 10% of all highway fuel use to be |
| | energy technology are eligible for a tax | blended gasoline | provided by alternative fuels by 2010, 15% by 2015 and |
| | credit equal to a percentage of the | when available: | 20% by 2020. |
| | investment made. | evaluate a | |
| | | purchase | |
| | | preference for | |
| | | biodiesel blends: | |
| | | and promote | |
| | | efficient operations | |
| | | of vehicles. | |
| Idaho | Tax deduction to licensed motor fuel | | |
| | distributors for the number of gallons of | | |
| | agricultural products or animal fats or | | |
| | the wastes of such products contained in | | |
| | biodiesel fuel. | | |
| Illinois | Illinois Clean School Bus program | The Illinois Green | Any diesel powered vehicle owned or operated by the |
| | provides funding to assist schools/school | Fleet Program | state, county or local government, school district, |
| | districts to reduce emissions from diesel | provides additional | community or public college or university, or mass |
| | powered school buses through emission | marketing | transit are required to use a biodiesel blend of at least 2% |
| | control retrofits, and implementation of | opportunities for | when refueling at a bulk central fueling station. |
| | cleaner fuels including biodiesel. | Fleets that have a | State agencies may give preference to an otherwise |
| | Rebate for 80% of the incremental cost | significant number | qualified bidder who will fulfill a contract through the |
| | of purchasing an AFV, SO % of the | of AFVs and use | use of vehicles powered by ethanol produced from |
| | incremental cost of fuel vehicle | American | Illinois coin or biodiesel fuel produced from Illinois |
| | conversion, and for the incremental cost | produced-fuels. | soybeans. |
| | of purchasing alternative fuels. The | Additionally, | |
| | rebate program is open to all Illinois | commercial or | |
| | residents, businesses, government units | retail fuel stations | |
| | except federal) and organizations located | that sell E85, | |
| | in Illinois | natural gas, | |
| | | propane, or other | |
| | | clean fuels as well | |
| | | as dealerships that | |
| | | promote the sale of | |
| | | AFVs and educate | |
| | | their customers | |
| | | about AFVs | |
| | | receive special | |
| | | recognition. | |
| Indiana | Taxpayers that produce blended | The OED and the | Government entities are required to fuel diesel vehicles |
| | biodiesel at a facility located in Indiana | ISDA provides | with biodiesel whenever possible. |
| | are eligible for a tax credit of $1 per | grants the help fuel | |
| | gallon of biodiesel that is used to | retailers increase | |
| | | the use of biofuels | |
| | produce blended biodiesel. | across the state, | |
| | Taxpayers that produce blended | Large fleet | |
| | biodiesel at a facility in Indiana are | operators are | |
| | entitled to a credit of $0.02 per gallon of | Eligible to apply | |
| | blended biodiesel. | for funding on | |
| | A taxpayer that is a fuel retailer and | projects that | |
| | distributes blended biodiesel for retail | include the | |
| | purposes is entitled to a credit of $0.01 | installation of E85 | |
| | per gallon of blended biodiesel | or B20 refueling | |
| | distributed for retail purposes. | infrastructure, | |
| | Government bodies, state educational | Matching funds of | |
| | institutions or instrumentality of the state | 50% are required. | |
| | that performs essential governmental | | |
| | functions on a statewide or local basis is | | |
| | entitled to a price preference of 10% for | | |
| | the purchase of fuels which are at least | | |
| | 20% biodiesel by volume, An area may | | |
| | be designated as a Certified Technology | | |
| | Park (allowing for certain tax incentives) | | |
| | if it meets certain criteria including a | | |
| | commitment from at least one business | | |
| | engaged in a high technology activity | | |
| | which involves electric vehicles, hybrid | | |
| | electric vehicles, or alternative fuel | | |
| | vehicles or components used in the | | |
| | construction of these vehicles. | | |
| Iowa | Through Dec. 31, 2011, retailers | | All state agencies must ensure that all bulk diesel fuel |
| | whose diesel sales are at least 50% | | procured contains at least 5% renewable content by |
| | biodiesel are eligible for a $0.03 per | | 2007, 10% by 2008, and 20% by 2010 provided that fuel |
| | gallon tax credit oil each gallon of B2 or | | meets ASTM D 6751 standards and is available. |
| | higher sold Biodiesel blenders may | | At least 10% of new light-duty vehicles purchased by |
| | apply for a cost-share grant for terminal | | institutions under the control of the state fleet |
| | distribution facilities' grants could cover | | administrator, IDOT administrator, BOD of community |
| | 50% of the costs of the project up to a | | colleges, state board of regents, commission for the |
| | max of $50,000K. 0% interest loans are | | blind, and Department of Corrections must be capable of |
| | available for tip to half the cost of | | using alternative feels. |
| | biomass or alternative fuel production | | |
| | related projects through Iowa's | | |
| | Alternative Energy Revolving Loan | | |
| | Program. | | |
| | AFV grants are awarded for research | | |
| | connected with the fuel or an AFV | | |
| | vehicle, but not for the purchase of the | | |
| | vehicle itself. | | |
| Kansas | A $0.30 per gallon incentive is | | A 2% or higher blend of biodiesel must be purchased for |
| | applicable to biodiesel fuel sold by a | | use in state-owned diesel vehicles and equipment, where |
| | qualified Kansas biodiesel fuel producer | | available, and as long as the incremental price does not |
| | Income tax credit for refueling stations | | exceed $.10 per gallon as compared to diesel fuel. |
| | placed in service after Jan. 1, 2005. | | Individuals operating state-owned vehicles must |
| | The tax credit may not exceed $160.000. | | purchase fuel blends containing at least 10% ethanol. |
| | | | For model year 2000 and thereafter, 75% of new light- |
| | | | duty vehicles acquired by the state fleet and its agencies, |
| | | | which are used in the metropolitan statistical area, are |
| | | | required to be ATVs. |
| Kentucky | An income tax credit is available for | | Kentucky Transportation Cabinet and the Finance and |
| | biodiesel producers and blenders at a | | Administration Cabinet employees using conventional |
| | rate of $1.00 per gallon. | | vehicles in the fleet are directed to use either E10 or B2 |
| | | | as their primary fuel option. |
| | | | The Transportation Cabinet is directed to maximize the |
| | | | use of E85 in its fleet flexible fuel vehicles. |
| Louisiana | Certain property acid equipment used in | | Renewable fuel plants operating in Louisiana and |
| | the manufacture production or extraction | | deriving ethanol from the distillation of corn must use at |
| | of unblended biodiesel, as well as | | least 20% corn crop harvested in Louisiana as feedstock. |
| | unblended biodiesel used as fuel bay a | | Renewable fuel plants operating in Louisiana and |
| | registered manufacturer, are exempt | | deriving biodiesel from soybeans and other crops must |
| | from state sales and use tax. | | use at least 2.5% of the soybean crop harvested in |
| | | | Louisiana as feedstock. |
| Maine | There is a state income tax credit of $.05 | | State agencies shall promote the procurement of |
| | per gallon for the commercial production | | dedicated alternative fuel vehicles dual fuel vehicles and |
| | of biofuels for use in motor vehicles or | | supporting refueling infrastructures. |
| | otherwise used as a substitute for liquid | | |
| | fuels. | | |
| | A tax credit is available for the | | |
| | construction or installation of, or | | |
| | improvements to any refueling or | | |
| | charging station for purposes of | | |
| | providing clean fuels to the general | | |
| | public for use in motor vehicles. The | | |
| | qualifying percentage is 25% for | | |
| | expenditures made from Jan. 01, 2002-Dec. 31, | | |
| | 2008. | | |
| | The Clean Fuel Vehicle fund provides | | |
| | non-lapsing revolving loans that may be | | |
| | used to finance all or part of any clean | | |
| | fuel vehicle project. | | |
| Maryland | Biodiesel producers may apply to the | | The state shall ensure that an average of 50% of fuel |
| | Renewable Fuels Incentive Board for | | used by bi-fuel and flex-fuel vehicles shall be alternative |
| | production credits. | | fuel. |
| | | | The state shall help develop the refueling and |
| | | | maintenance infrastructure required to make using |
| | | | certain types of AFVs practical. |
| | | | At least 50% of the state vehicles must use a minimum |
| | | | biodiesel blend of B5 by the beginning of the 2008 fiscal |
| | | | year. |
| Massachusetts | | | State fleets must acquire AFVs according to the |
| | | | requirements of the EPAct of 1992. |
| Michigan | Tax exemption may apply to an | | |
| | industrial property which is used for, | | |
| | among other purposes, high-technology | | |
| | activities or the creation or synthesis of | | |
| | biodiesel fuel. | | |
| | A matching grant program available to | | |
| | service stations to convert existing, and | | |
| | install new, fuel delivery systems to | | |
| | provide E85 and biodiesel blends. | | |
| Minnesota | | | State agencies are required to take all reasonable actions |
| | | | necessary to strengthen the infrastructure for increasing |
| | | | the availability and use of E85 and biodiesel throughout |
| | | | the state. |
| | | | Employees using state vehicles are expected to use E85 |
| | | | whenever it is available. |
| | | | The state is required to achieve a 25% and 50% |
| | | | reduction in the use of gasoline for state department |
| | | | owned vehicles by 2010 and 2015 respectively. All |
| | | | diesel fuel sold or offered for sale in the state for use in |
| | | | internal combustion engines roust contain at least 2% |
| | | | biofuel by volume. State agencies are required to use |
| | | | alternative fuels in state motor vehicles if the clean fuels |
| | | | are reasonable available at similar cost to other fuels and |
| | | | are compatible with the intended use of the vehicle. |
| Mississippi | Incentive of $0.20 per biodiesel gallons | | |
| | produced annually up to 30 million | | |
| | gallons per year, per producer for tip to | | |
| | 10 years | | |
| Missouri | Grants available to qualified biodiesel | The Biodiesel Fuel | At least 75% of the MoDOT vehicle fleet and heavy |
| | producers, $0.30 per gallon for the first | Revolving Fund | equipment that use diesel fuel must be fueled with B20 |
| | 15 million gallons produced in a fiscal | uses money | or higher biodiesel blends, if such fuel is commercially |
| | year, $0.10 per gallon for the next 15 | generated by the | made. |
| | million gallons in a fiscal year, up to 30 | sale of EPAct | Any state agency operating a fleet of more than 15 |
| | million gallons per year for 60 months. | credits to cover the | vehicles must ensure that 50% of new vehicles acquired |
| | Restrictions apply, School districts who | incremental cost of | are capable of running on alternative fuels 30% of the |
| | establish a contract with an eligible new | purchasing fuel | fuel purchased annually for use in state vehicles must be |
| | generation coop for biodiesel will | containing B20 or | alternative fuel. |
| | receive an additional payment to offset | higher fuel blends | |
| | the incremental cost of the fuel | for state fleet | |
| | | vehicles. | |
| Montana | A tax credit available to businesses and | | |
| | individuals for up to 15% of the cost of | | |
| | storage and blending equipment used for | | |
| | blending biodiesel with petroleum diesel. | | |
| | Licensed distributors paying special tax | | |
| | fuel on biodiesel may claim a refund of | | |
| | $0.02 per gallon sold during the previous | | |
| | year if all ingredients of the biodiesel | | |
| | were produced in state. | | |
| | Owner/operators of retail motor Kiel | | |
| | outlet may claim a refund of $0.01 per | | |
| | gallon of biodiesel purchased from a | | |
| | licenses distributor if the biodiesel | | |
| | ingredients were all produced in state. | | |
| | A tax credit for up to 15% of the cost to | | |
| | construct and equip a biodiesel | | |
| | production facility Income tax credit for | | |
| | up to 50% of the labor & equipment cost | | |
| | to convert vehicles to use alternative | | |
| | fuels. (business Individual) | | |
| Nebraska | Motors fuels sold to a biodiesel | | State employees operating state fleet flexible-fuel or |
| | production facility and that | | diesel vehicles are required to use E85 or biodiesel |
| | manufactured at same are exempt from | | blends whenever reasonable available. |
| | certain motor fuel taxes laws. | | |
| | The NEO offers low-cost loans for a | | |
| | variety of alternative fuel projects. | | |
| Nevada | | | State (agencies, political subdivisions) fleets containing |
| | | | 10 or more vehicles in a county whose population is |
| | | | 100.000 or more are required to acquire AFVs or EPA |
| | | | certified low emission vehicles. |
| | | | Beginning in 2000 and each year thereafter, 90% of new |
| | | | vehicles obtained by covered fleets must be either AFVs |
| | | | or certified ULEVS. |
| New | | | State agencies are required to implement a Clean Fleets |
| Hampshire | | | Program. |
| New Jersey | Rebate offered to government entities for | | All buses purchased by the New Jersey Transit Corp. |
| | the incremental costs of purchasing | | must be equipped with improved pollution controls and |
| | AFVs or converting vehicles to use | | be powered by a fuel other than conventional diesel |
| | alternative fuels | | |
| | Rebate to local governments, state | | |
| | colleges/universities, school districts and | | |
| | governmental authorities for the | | |
| | incremental cost of using biodiesel fuel. | | |
| New Mexico | The value of biomass materials used for | $5 million | By 2010 all cabinet level state agencies, public schools |
| | processing into biofuels may be | revolving (low | and institutions of higher education are required to take |
| | deducted in computing the compensating | interest) loans | action toward obtaining at least 15% of their total |
| | tax due. | available for AFV | transportation fuel requirements from renewable fuels. |
| | Grants available to eligible participants | acquisitions by | 75% of state government and educational Institutions |
| | to support alternative fuel activities such | state agencies, | fleet vehicles acquired after 2003 be bi-fuel or dedicated |
| | as infrastructure development. | political | AFVs or gas-electric hybrid vehicles. |
| | Alternative fuel purchased for | subdivisions and | |
| | distribution shall not be subject to the | educational | |
| | excise tax at the time of purchase or | institutions. | |
| | acquisition. | | |
| | Alternative fuel purchased for | | |
| | distribution shall not be subject to the | | |
| | alternative fuel excise tax at the time of | | |
| | purchase or acquisition, but the tax shall | | |
| | be due on alternative fuel at the time it is | | |
| | dispensed or delivered into the tank of a | | |
| | motor vehicle that is operated on the | | |
| | highways of the state. | | |
| New York | A tax credit equal to up to 50% of the | Funds are provided | At least 80% of New York's light-duty, non-emergency |
| | cost of infrastructure including | to state and local | fleet, and 20% of bus Elects operated iii New York City |
| | infrastructure for storing or dispensing | transit agencies, | are required to be AFVS. |
| | clean burning fuel into the tank of a | municipalities, and | By 2010, 100% of all new light-duty (some exceptions) |
| | motor vehicle, | schools for up to | vehicles must be AFVs. |
| | | 100% of the | To the extent that gasoline powered state vehicles use |
| | | incremental cost of | central refueling stations, all state agencies and public |
| | | purchasing new | authorities must use E85 in flexible fuel vehicles |
| | | alternative fuel | whenever it is feasible to do so. |
| | | buses. Funds | |
| | | awarded to | |
| | | NYCCC that | |
| | | acquire AFVs and | |
| | | or refueling | |
| | | infrastructure. | |
| | | Components | |
| | | included are, | |
| | | incremental cost of | |
| | | purchasing AFVs, | |
| | | the cost of | |
| | | installing refueling | |
| | | and recharging | |
| | | equipment, and the | |
| | | incremental costs | |
| | | with bulk | |
| | | alternative fuel | |
| | | purchases | |
| North Carolina | A tax credit equal to the per gallon | | |
| | excise tax paid is an available to a | | |
| | biodiesel provider that produces at least | | |
| | 100,000 gallons during the taxable year. | | |
| | A taxpayer that constructs 3 or more | | |
| | renewable fuel processing facilities in | | |
| | state and invest at least $400,000,000 are | | |
| | eligible for a credit equal to 35% of the | | |
| | cost of constructing and equipping said | | |
| | facility. Taxpayers who construct, | | |
| | purchase or lease renewable energy | | |
| | property is eligible for a tax credit equal | | |
| | to 35% of the cost of the property. | | |
| | A tax credit equal to 15% of the cost of | | |
| | constructing and installing portion of a | | |
| | dispensing facility, including pumps, | | |
| | storage tanks and related equipment that | | |
| | is directly used for dispensing or storing | | |
| | biodiesel fuel Chants for the incremental | | |
| | cost of purchasing OEM AFVs vehicle | | |
| | retrofits implementing idle reduction | | |
| | programs, and constructing or installing | | |
| | alternative fuel public refueling | | |
| | facilities. | | |
| | The NCSPA offers new dealers and | | |
| | distributors of soy biodiesel a rebate on | | |
| | the first 250 of 500 gallons purchased | | |
| | and a 50% rebate to cover die cost of | | |
| | equipment changes needed to begin | | |
| | selling soy biodiesel | | |
| North Dakota | 5-year corporate income tax credit (up to | | |
| | 10% per year) for equipment that | | |
| | enables a facility to sell diesel fuel which | | |
| | contains 2% biodiesel by volume. | | |
| | Licensed fuel supplier who blends | | |
| | biodiesel into fuel comprised of at least | | |
| | 5% biodiesel is entitled to a tax credit of | | |
| | $0.05 per gallon of biodiesel fuel. | | |
| | Funds are available to participate in an | | |
| | Interest rate buy down on a loan to a | | |
| | biodiesel production facility for the | | |
| | following uses: purchase of real property | | |
| | and equipment; expansion of facilities; | | |
| | working capital and inventory. | | |
| | Reduction of $0.0105 per gallon | | |
| | reduction of state excise tax for the sales | | |
| | or delivery of diesel fuel containing at | | |
| | least 2% biodiesel fuel by weight. | | |
| Ohio | Funding, not to exceed 50% of total | | The ODOT fleet is required to use at least one million |
| | costs, is provided to retail fuel stations to | | gallons of biodiesel and 30,000 gallons of ethanol in fleet |
| | assist with installation and promotion of | | vehicles each year. |
| | E85 and or B20. | | All new ODOT vehicle purchases must be flexible fuel |
| | | | vehicles capable of operating on E85. |
| Oklahoma | A biodiesel (B1OQj production facility | A private loan | Law requires that all school and government vehicles |
| | is allowed a tax credit of $0.20 per | program with a 3% | capable of operating on alternative fuel to use the fuel |
| | gallon of biodiesel produced. | interest rate is | whenever a refueling station is in operation within a five- |
| | (Restrictions apply) | available for the | mile radius of the respective department or district. |
| | The Alternative Fuel Loan program has | cost of converting | |
| | funds available to help convert | private fleets to | |
| | government-owned fleets to operate on | operate on | |
| | alternative fuels. | alternative fuels, | |
| | | for incremental | |
| | | costs of purchasing | |
| | | OEM AFVs and | |
| | | for the installation | |
| | | of AFV fueling | |
| | | infrastructure. | |
| Oregon | Tax credit for business owners to offset | | State agencies and transit districts must purchase AFVs |
| | the incremental cost of purchasing | | to the extent possible. |
| | AFVs, the cost of converting vehicles to | | |
| | use alternative fuel, and the cost of | | |
| | constructing alternative fuel refueling | | |
| | stations. Credit equals 35% of | | |
| | incremental costs. | | |
| | Loan program available for alternative | | |
| | fuel projects including feel production | | |
| | facilities, dedicated feedstock | | |
| | production, fueling stations and fleet | | |
| | vehicles. | | |
| Pennsylvania | Tile Alternative Fuel Incentive Grant | | |
| | Fund provides funding to various | | |
| | governments, educational and non-profit | | |
| | organizations for projects with an | | |
| | emphasis on biofuels. | | |
| Rhode Island | Tax credit to taxpayers equal to 50% of | | |
| | the capital labor, and equipment costs for | | |
| | the construction of, or improvements to, | | |
| | any alternative fuel refueling or | | |
| | recharging station proving domestically | | |
| | produced alternative fuel. | | |
| | Corporations selling alternative fuels are | | |
| | allowed gross earnings from sales | | |
| | reduction equal to the total gross | | |
| | earnings from the sale of alternative | | |
| | fuels. | | |
| | The RISEO offers low fee loans to state | | |
| | agencies and municipal governments to | | |
| | cover incremental costs of purchasing | | |
| | original equipment manufactured AFVs. | | |
| | Organically produced biofuels are | | |
| | exempt from motor fuel tax. | | |
| South Carolina | A $0.05 payment is available to | | State agencies operating Alternative Fuel Vehicles are |
| | biodiesel retailers for each gallon of B20 | | required to use alternative fuel in those vehicles |
| | sold, provided the B20 fuel is subject to | | whenever practical and economically feasible. |
| | the S.C. motor fuel tax and the price of | | |
| | the lowest price of the B20 fuel is at | | |
| | least $0.05 lower than the priced non- | | |
| | B20 fuel being sold at the same facility. | | |
| | Business tax credits of $0.20 for each | | |
| | gallon of biodiesel motor fuel produced | | |
| | mostly from soybean and sold as well as | | |
| | a credit of $0.30 for each gallon of | | |
| | biodiesel motor fuel a majority of which | | |
| | is produced from feedstock other than | | |
| | soybean Tax credit for biodiesel | | |
| | facilities that were placed in use after | | |
| | 2006 and in production at the rate of at | | |
| | least 25% of the nameplate design | | |
| | capacity by Dec. 31, 2009. Credit equals | | |
| | $0.20 per gallon of biodiesel produced | | |
| | and is allowed beginning die first month | | |
| | the facility is eligible. A tax credit for | | |
| | 25% of the cost for constructing or | | |
| | installing equipment for the installation | | |
| | of a qualified commercial facility that | | |
| | distributes or dispenses ethanol or | | |
| | biodiesel. | | |
| South Dakota | Tax refund for contractors” excise and | | The SDDoT and state employees using state diesel |
| | sales and use taxes paid for construction | | vehicles are required to use a minimum 2% biodiesel |
| | of new or expansion of existing | | blended fuel which meets or exceeds the STM |
| | agricultural processing plant used for the | | specifications. |
| | production of biodiesel. | | |
| Tennessee | TDOT grants available to help fund | | |
| | capital costs to purchase, prepare, and | | |
| | install biofuel storage tanks and fuel | | |
| | pumps at private sector fuel stations | | |
| | Grants for county governments to install | | |
| | biodiesel infrastructure which will | | |
| | provide biodiesel fuel to county city | | |
| | owned vehicles. Funds granted for up to | | |
| | 50% of total project cost. | | |
| Texas | A non-profit grant program offers aid to | Grants for up to | |
| | local school districts in replacing aging | 75% of the | |
| | diesel fuel buses with new clean fuel | incremental cost to | |
| | buses. | purchase new | |
| | | OEM clean fuel | |
| | | vehicles and or | |
| | | conversions/repowers. | |
| | | Limited to the | |
| | | 8 county Houston- | |
| | | Galveston non- | |
| | | attainment area. | |
| Utah | Income tax for 50% of incremental | | The UAQB is authorized to mandate fleet vehicles to use |
| | purchase cost of an OEM clean fuel | | clean fuels, if such a mandate is necessary in order to |
| | vehicle and or the conversion of a | | meet national air quality standards |
| | vehicle to operate of alternative fuel. | | |
| Vermont | Businesses that exclusively design | | The commissioner of building and general services must |
| | develop and manufacture EVs. AFVs or | | consider ATVs when purchasing fleet vehicles for the |
| | hybrid vehicles are eligible for income | | state. |
| | tax credits. | | |
| Virginia | The Biofuels Production Fund provides | | State agencies are requested to use biofuels where |
| | grants to producers of biofuels, | | feasible in fleet vehicles owned by the state or operated |
| | specifically ethanol and biodiesel. | | by the agency. |
| Washington | A tax deduction is available for the sale | | State agencies are encouraged to use a fuel blend of 20% |
| | or distribution of biodiesel or alcohol | | biodiesel and 80% petroleum diesel (B20) for use in |
| | fuel. | | diesel-powered vehicles. 85% of money received by an |
| | Fuel delivery vehicles and machinery, | | air pollution control authority or the State Department of |
| | equipment and related services are | | Licensing must be used for the Clean Bus Program to |
| | exempt from state retail fuel sales and | | retrofit buses to use cleaner burning fuels. At least 30% |
| | use taxes. | | of all new vehicles purchased through state contract must |
| | Until 2009, investment in buildings, | | be clean-fuel vehicles. |
| | equipment and labor for the purpose of | | |
| | manufacturing biodiesel, biodiesel | | |
| | feedstock, or alcohol fuel are eligible for | | |
| | deferral of state and local sales and use | | |
| | taxes. | | |
| | Qualifying buildings, equipment, and | | |
| | land uses in the manufacturing of | | |
| | alcohol fuels, biodiesel, or biodiesel | | |
| | feedstock are exempt from state and | | |
| | local property and leasehold taxes for a | | |
| | period of six years, reduced Business & | | |
| | Occupation tax rate applies to persons | | |
| | engaged in the manufacturing of alcohol | | |
| | fuel, biodiesel fuel or biodiesel | | |
| | feed stock. | | |
| West Virginia | | | The Secretary of Administration has the authority to |
| | | | require state, county municipal government fleets to |
| | | | make 75% of fleet purchases AFVs. |
| Wisconsin | The DPI may provide aid to school | | |
| | districts that use biodiesel fuel for | | |
| | .school bus transportation to cover the | | |
| | incremental cost of using biodiesel as | | |
| | compared to the cost of petroleum | | |
| | diesel. | | |

Depending on the final composition of the product produced according to the methods of the invention, various Federal and State tax credits and other production incentives are available. The procedure for obtaining tax credits under U.S. Code Title 26 section 6426 and 40A, for example, depends on which components meet Biodiesel, Agri-biodiesel, or Alternative Fuel definitions and specifications. The procedure for obtaining renewable fuel treatment and generating RINs under the EPA Clean Air Act as amended by the Energy Independence and Security Act of 2007 depends on whether the esters meet Biodiesel, Advanced Biofuels or Biomass-based fuels definitions and specifications.

In order to claim Federal tax credits, the claimant must first apply and be approved for “Certain Excise Tax Activities” registration. Once this is accomplished, and depending on whether the claimant will be claiming the tax credit directly or not, certain record-keeping requirements must be met and claims for tax credits filed.

As noted above, the product of the method of the invention can be blended with taxable fuel prior to sale or use under Section 6426. When this is done, the tax credits, if available, are refundable. Alternatively, the product can be used by the tax payer without blending or placed directly in the tank of an end user at retail in order to generate non-refundable credits under Section 40A.

If the producer qualifies under Section 40A as a small Agri-Biodiesel producer, then Section 40A small Agri-Biodiesel producer credits, if available, can be claimed.

### Production of Ester Fuels

Biodiesel and Agri-Biodiesel fuels consist primarily of esters of fatty acids, particularly methyl esters. Generally, the formation of esters from carboxylic acids, for example, proceeds according to the following reaction:

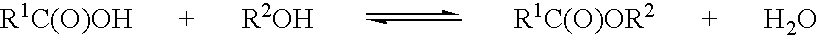

where R¹ is hydrogen or a monovalent organic radical and R² is a monovalent organic radical. As noted previously, fatty acid esters can also be produced by transesterification where by glycerides are reacted with alcohols in the presence of acid or base catalysts to yield esters and glycerin. Production of fatty acid esters by transesterification generally produces a product stream having salts and soaps resulting from treatment with acids and/or bases, and a significant concentration of unreacted glycerin. Esterification of fatty acids according to the present invention allows for the inclusion of glycerin in the feedstock without undue consequence to the resulting product.

Other esters of other carboxylic acids can also be prepared according to the method of the invention. For example, rosin acids from paper making and cellulosic ethanol production can be esterified and then sold as fuel.

The process of the present invention employs the vapor stream of the more volatile of the two components, (i.e. the more volatile out of the fatty acid component and the alcohol component), to carry away water produced in the esterification reactor, while advantageously not carrying away a significant quantity of the less volatile component. For this reason it is essential in one embodiment that the boiling point of the vapor mixture exiting the esterification reactor, or of the highest boiling compound present in that vapor mixture, be significantly lower, at the pressure prevailing in the uppermost stage of the esterification reactor, than the boiling point at that pressure of either of the less volatile one of the two components. The term “significantly lower” shall mean that the boiling point difference shall be at least about 20° C., and preferably at least about 25° C., at the relevant operating pressure of the column. In the practice, the more volatile component of the two will frequently be the alcohol component. For example methanol will be the more volatile component in the production from fatty acid mixtures obtained by the hydrolysis of triglycerides of methyl fatty acid ester mixtures for subsequent processing, for example for production of detergent alcohols by ester hydrogenation.

Whereas typical esterification processes employ pure or nearly pure (i.e., 99% or greater) fatty acid feed stocks, the present invention provides a process wherein the feedstock may comprise at least 2% glycerin, at least 3%, at least 4%, at least 5%, at least 6%, at least 7%, at least 8%, at least 9%, or at least 10% glycerin included in the fatty acid feedstock as a result of the splitting of the triglycerides.

Generally, any source of triglycerides can be used to prepare the fatty acid ester derivatives that provides a fuel additive composition with the desired properties. Suitable fatty acids for esterification include, but are not limited to, fatty acids such as decanoic acid, dodecanoic acid, tetradecanoic acid, hexadecanoic,acid, octadecanoic acid, octadecenoic acid, linoleic acid, eicosanoic acid, isostearic acid and the like, as well as mixtures of two or more thereof. Mixtures of fatty acids are produced commercially by hydrolysis of naturally occurring triglycerides of vegetable origin, such as coconut oil, rape seed oil, and palm oils, tall oils and triglycerides of animal origin, such as lard, bacon grease, yellow grease, tallow and fish oils. Additional triglycerides may be sourced from whale oil and poultry fat, as well as corn, palm kernel, soybean, olive, sesame, and any other oils of animal or vegetal origin not explicitly identified herein. Other sources of fatty acids include algae (eukaryotic or prokaryotic or mixed), bacteria, and fungi. Other whole plant oils are also suitable. The soaps generated in the refining of tall oil, soybean oil, rapeseed oil, canola oil, and palm oil can also be acidulated by methods known to those skilled in the art to yield fatty acids suitable for esterification and generation of tax credits under the method of the current invention. In general, while fatty acid esters are preferred for generating the higher level of tax credits, esters of rosin acids can also be utilized according to the present invention.

If desired, mixtures of acids can be subjected to distillation to remove lower boiling acids having a lower boiling point than a chosen temperature (e.g. C₈ to C₁₀ acids) and thus produce a “topped” mixture of acids. Optionally, the mixtures can be distilled to remove higher boiling acids having a boiling point higher than a second chosen temperature (e.g. C₂₂+ acids) and thus produce a “tailed” mixture of acids. Additionally, both lower and higher boiling acids may be removed and thus produce a “topped and tailed” mixture of acids. Such fatty acid mixtures may also contain ethylenically unsaturated acids such as oleic acid. These fatty acid mixtures can be esterified with methanol to yield methyl fatty acid ester mixtures.

In another aspect of the present invention, biodiesel fuels prepared according to the present invention are provided. Sulfur content of the biodiesel fuel is one of many parameters of interest for commercial use. Sulfur is typically present as a result of the use of sulfuric acid catalysts, and can result in increased engine wear and deposits. Additionally, environmental concerns dictate a desired low sulfur content in the biodiesel fuel. Preferably, biodiesels prepared according the methods provided herein have a sulfur content (as measured by ASTM test method D5453) of less than 500 ppm, more preferably less than 200 ppm, less than 100 ppm, less than 50 ppm, less than 25 ppm, less than 10 ppm, and most preferably less than 5 ppm.

It is preferred that biodiesel fuels prepared according to the present method have a relatively high flash point, preferably greater than 130° C., more preferably greater than 140° C., even more preferably greater than 150° C., and most preferably greater than 160° C.

The cetane number (i.e., the measure of the ignition quality of the fuel, as measured by ASTM test methods D976 or D4737) is preferably greater than 47, more preferably greater than 50, and most preferably greater than 55.

Cloud points are defined as the temperature at which a cloud or haze of crystals appears in the fuel. Cloud points determine the climate and season in which the biodiesel fuel may be used. Preferably the cloud point of the biodiesel is less than 0° C., more preferably less than −5° C., less than −10° C., less than −15° C., less than −20° C., less than −25° C., less than −30° C., less than −35° C., less than −40° C., and most preferably, less than −45° C.

Total free glycerin in the biodiesel is preferably less than 0.03% by weight, more preferably less than 0.20% by weight, less than 0.018% by weight, less than 0.016% by weight, and most preferably, less than 0.015% by weight. Total glycerin present in the biodiesel fuel is preferably less than 0.25% by weight, more preferably less than 0.24% by weight, less than 0.23% by weight, less than 0.22% by weight, 0.21% by weight, and most preferably, less than 0.20% by weight.

Residual methanol in the biodiesel is desired to be minimized, and is preferably less than 0.2% by weight, more preferably less than 0.18% by weight, and most preferably less than 0.15% by weight.

Water content in the biodiesel fuel produced according the present invention is preferably less than 500 ppm, preferably less than 450 ppm, more preferably less than 400 ppm and most preferably less than 300 ppm.

It can be important to define a minimum viscosity of the biodiesel fuel because of power loss due to injection pump and injector leakage. Preferably, the viscosity of the biodiesel fuel is between 1.0 and 8.0 mm²/s, more preferably between 1.9 and 6.0 mm²/s, even more preferably between 3.5 and 5.0 mm²/s.

### Alcohols

A variety of alcohols may be suitable for use in the present etherification reaction, including any C₁₋₆ straight, branched, or cyclic alcohols. Preferably, the alcohol is selected from t-butanol or isobutanol, or a mixture thereof.

The alcohols employed are preferably anhydrous, however the presence of a small amount of water is acceptable for the present reaction.

### Catalyst

The esterification reaction of the present invention preferably employs a solid heterogeneous catalyst having acidic functional groups on the surface thereof. By heterogeneous is meant that the catalyst is a solid, whereas the reactants are in gaseous and liquid state, respectively.

The solid esterification catalyst may be a granular ion exchange resin containing —SO₃H and/or —COOH groups. Macroreticular resins of this type are preferred. Examples of suitable resins are those sold under the trade marks AMBERLYST, DOWEX, DOW, and PUROLITE such as AMBERLYST 13, AMBERLYST 66, DOW C351 and PUROLITE C150.

The catalyst used on each tray or similar vapor liquid equilibrium affecting device can be a single solid esterification catalyst selected from particulate ion exchange resins having acidic groups. A synthetic zeolite or other type of mixed or singular oxide ceramic material with sufficient acidity could also be employed. Furthermore, different trays or stages could contain different catalyst. In other cases, even when a monocarboxylic acid ester is the desired product, the alcohol component and the carboxylic acid component can be reacted to equilibrium in the presence of an acidic ion exchange resin prior to introduction of the resulting equilibrium mixture to the column reactor.

Solid particulate catalyst may also be employed. In this case, the charge of solid particulate or granular esterification catalyst on each tray is typically sufficient to provide a catalyst:liquid ratio on that tray corresponding to a resin concentration of at least 0.2% w/v, for example a resin concentration in the range of from about 2% w/v to about 20% w/v, preferably 5% w/v to 10% w/v, calculated as dry resin. Sufficient catalyst should be used to enable equilibrium or near equilibrium conditions to be established on the tray within the selected residence time at the relevant operating conditions. Additionally, the amount of catalyst on each tray should be maintained such that agitation by the upflowing vapor is sufficient to prevent “dead spots.” For a typical resin catalyst a resin concentration in the range of from about 2% v/v to about 20% v/v, preferably 5% v/v to 10% v/v may be used.

### Reaction Vessel

The present invention may be practiced in a variety of reaction vessels, preferably in distillation columns having a variety of catalyst arrangements. Preferably, the vessel includes a reaction zone providing means for sufficiently contacting the reactants in the presence of a catalyst. Such means may include a plurality of trays, or structured packing that operates similar to the trays in a column. A suitable distillation column for reactive distillation according to the present invention is described in U.S. Pat. No. 5,536,856 (Harrison et al.) which is incorporated herein by reference. A different design for the equilibrium stages is described in U.S. Pat. No. 5,831,120 (Watson et al.), and Sulzer sales brochures (“Katapak: Catalysts and Catalyst Supports with Open Crossflow Structure” by Sulzer Chemtech (undated)), each of which is incorporated herein by reference.

Exemplary structured packing preferably includes porous catalyst supports and flow channels for the stripping gas between the catalyst supports. In the flow channels, the downward directed flow of the liquid and the upwardly directed stripping gas contact, in the presence of the acidic solid catalyst, so the esterification can take place.

Preferably, the catalyst is macroporous. Additionally, the catalyst selected must have sufficient stability (i.e., minimal loss of activity) at the operating temperatures necessary, depending upon the alcohol component of the reaction. For example, if methanol, ethanol, n-propanol, isopropanol, n-butanol, tert-butanol or isobutanol is selected as the alcohol, then the catalyst (for example, an ion exchange resin), must be able to be used at temperatures between 120° C. and 140° C.; and must only moderately lose activity in this temperature range. If however, 2-ethyl-hexanol is selected as the alcohol component, then the catalyst should be usable at higher temperatures, such as for example, approximately 150° to 230° C.

In certain embodiments, the catalyst can be a fixed-bed catalyst. In a fixed bed arrangement, the reaction vessel can be operated as a trickle column of which about 30 to 60 vol %, preferably 50 vol % are utilized by the stripping gas as free gas space, whereas 30 to 50 vol %, preferably 40 vol % of the column is occupied by solid substance, i.e. the fixed-bed catalyst. The remaining reaction space, preferably 10 vol % or less, is occupied by the trickling liquid. When using a fixed bed, the residence time of the liquid phase can be adjusted by the stripping gas velocity. The residence time of the liquid phase is high with higher velocities of the stripping gas volume. Generally, the stripping gas throughput can be adjusted in a wide range without having an adverse effect on the course of process.

### Reaction Conditions

The esterification conditions used in a distillation reactor according to the present invention will normally include the use of elevated temperatures up to about 160° C. Typically, the reaction conditions are determined based upon the boiling point of the less volatile component, typically the alcohol component. Generally, the esterification reaction may be conducted at a temperature in the range of from about 80° C. to about 140° C., preferably in the range of from about 100° C. to about 125° C. The particular operating temperature of the reaction is also determined based on the thermal stability of the esterification catalyst, the kinetics of the reaction and the vapor temperature of the less volatile component at the relevant inlet pressure. Typical operating pressures at the inlet of the column reactor may range from about 0.1 bar to about 25 bar. Additionally, the liquid hourly space velocity through the column reactor may range of from about 0.1 hr⁻¹ to about 10 hr⁻¹, typically from about 0.2 hr⁻¹ to about 2 hr⁻¹, may be used.

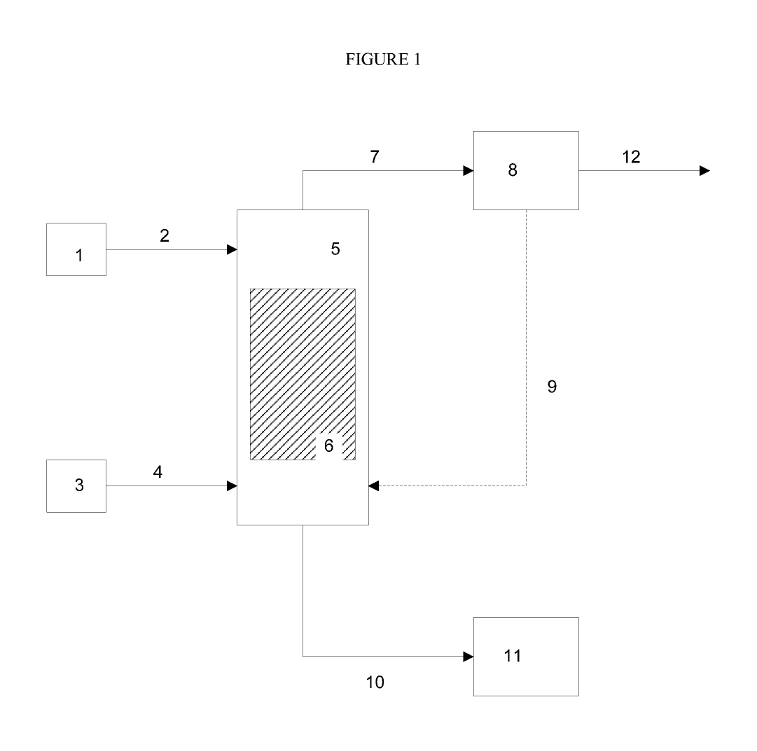

Referring now to FIG. 1, there is provided an embodiment of a process for the esterification of fatty acid feed stock having between 1-10% glycerin. A fatty acid feedstock 1 is supplied to column 5 via line 2. If the fatty acid is the less volatile component (compared to the alcohol), then fatty acid 1 is supplied to the upper portion of the column, preferable above a reaction zone 6. An alcohol 3, preferably methanol, is supplied to the column via line 4. If the alcohol is the more volatile component (compared with the fatty acid), then the alcohol 3 is supplied to the bottom of column 5, preferably below the reaction zone 6.

The reaction zone 6 preferably includes trays or structured packing which includes a heterogeneous catalyst, preferably an ion exchange resin having acidic functional groups. If structured packing is employed, preferably achieving the same vapor-liquid contact as is accomplished with trays. One of skill in the art can determine the equivalent size and type of packing for a given number of trays in a distillation column.

The alcohol is introduced at the bottom of the column as a vapor, traveling upward through the trays, and preferably contacting the fatty acid in the reaction zone in the presence of the appropriate esterification catalyst. Column 5 preferably includes means for heating the alcohol to produce a vapor stream. The alcohol stream exits column 5 via line 7, preferably including at least a portion of the water produced by the esterification reaction.

The alcohol stream can be supplied to an alcohol/water separation unit 8, which separates the stream into a water-rich stream 12 and an alcohol rich stream 9, which can be recycled to the distillation column 5.

Product stream 10 exits the distillation column as the bottoms liquid, and includes fatty acid alkyl ethers and glycerin. The bottoms stream 10 may also include mono-, di- and tri-alkyl ethers of glycerin.

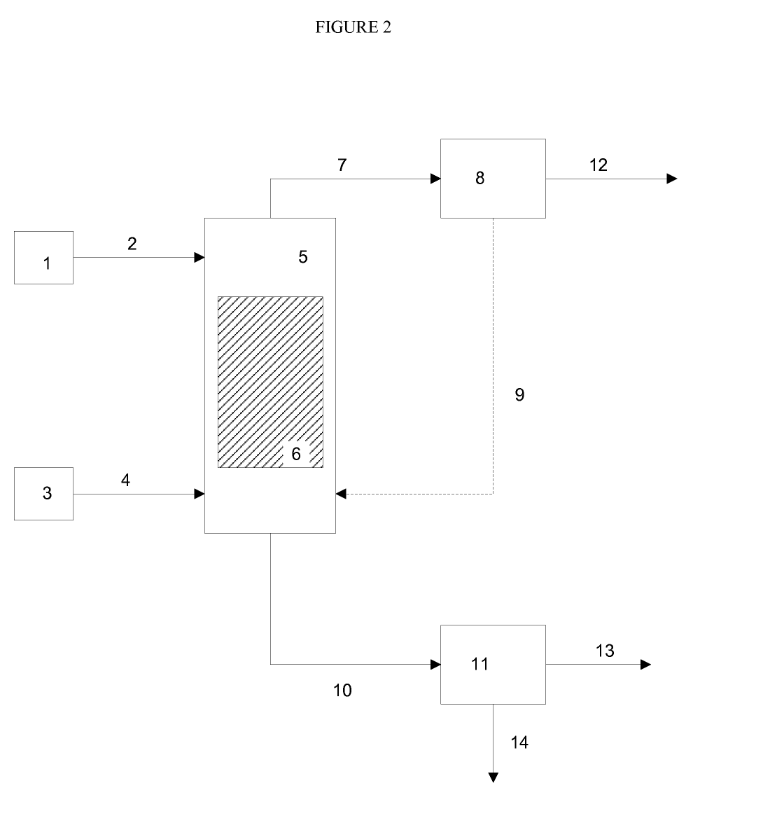

Referring now to FIG. 2, an alternate embodiment of the process shown in FIG. 1 is presented. FIG. 2 shows the process of FIG. 1, and further employs a means for separating 11 the product stream 10. The means can be any means known in the art for the separation of glycerin and unreacted fatty acids from the product esters, such as for example, using a settling tank, distillation, reboiled stripping, inert gas stripping, or physical adsorption. The separation means 11 results in a ester-rich stream 13 and a glycerin or fatty acid containing stream 14.

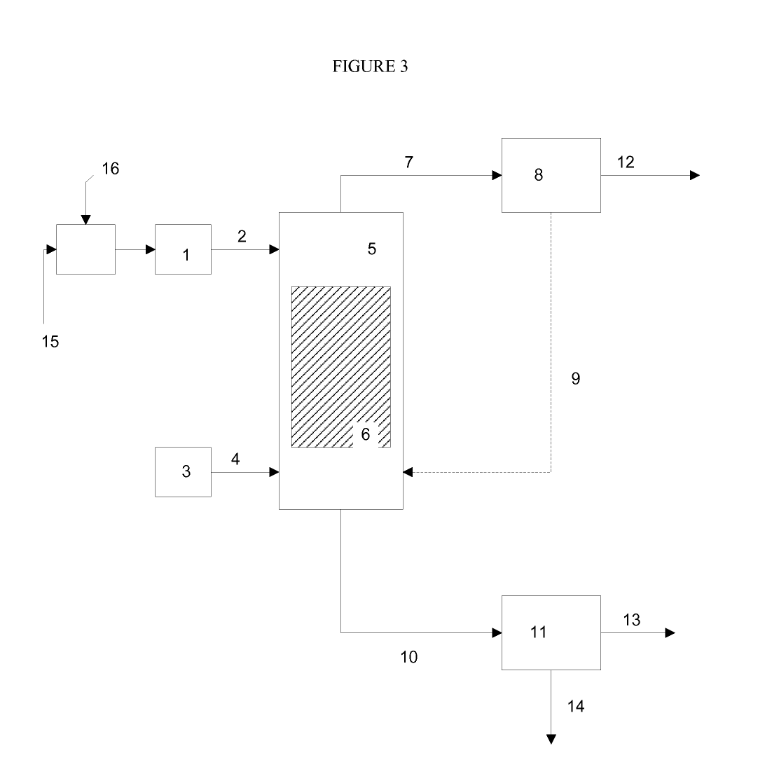

Referring to FIG. 3, the embodiment according to FIG. 2 is provided, further including a pre-esterification unit 16, to which the glycerin/fatty acid feed stock is introduced via line 15. The use of a pre-esterification unit is known in the art, such as is described in U.S. Pat. No. 5,536,856 (Harrison et al.) and incorporated herein by reference.

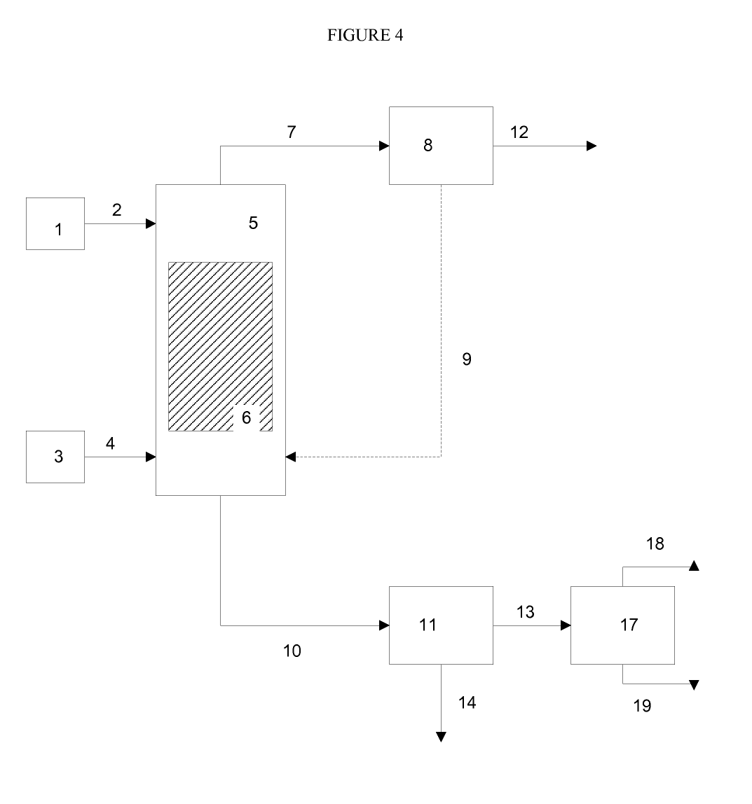

Referring now to FIG. 4, the embodiment according to FIG. 1 is provided, further including means for separating glycerin and the fatty acid ester product of line 13. Accordingly, the product mixture is supplied to a settling tank 17 via line 13. The contents of the tank are allowed to settle, and the fatty acid esters 18 may be separated from the glycerin 19.

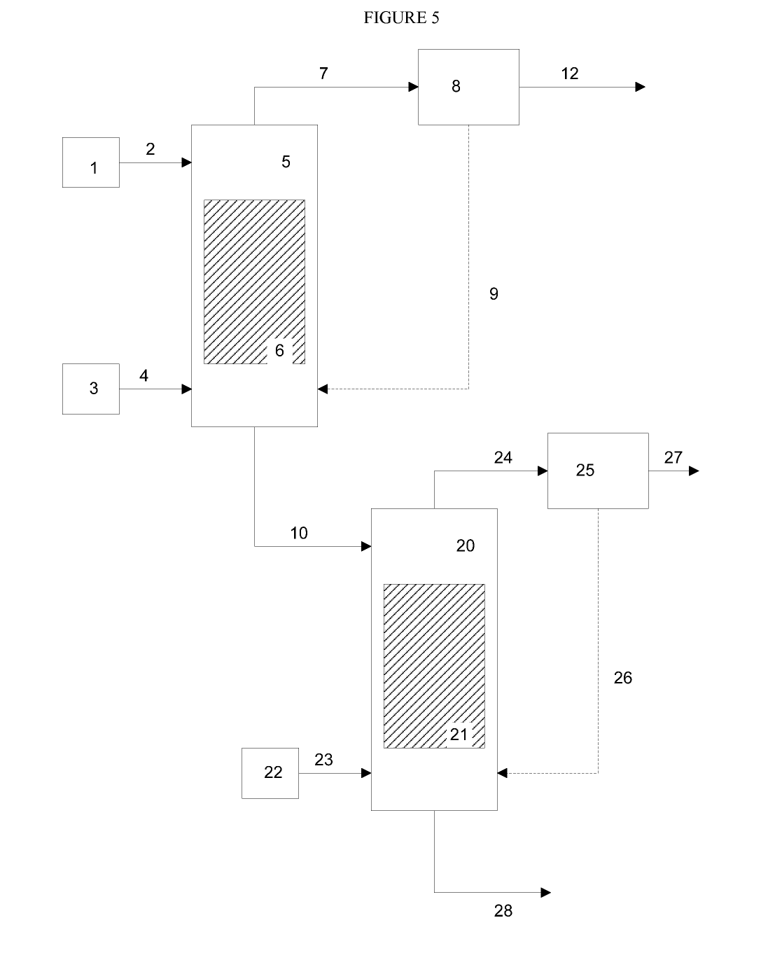

Referring now to FIG. 5, an alternate embodiment of the process according to FIG. 1 is provided, further including means for producing a biodiesel feed which includes glycerin ether additives. The glycerin ether additives are produced by reacting glycerin with an alcohol in the at a proper temperature and pressure, in the presence of a catalyst, to produce a mixture of mono-, di- and tri-ethers of glycerin.

Crude fatty acid ester product stream 10, which may contain glycerin and unreacted fatty acids, is introduced to a second reaction vessel 20. Reaction vessel 20 is preferably a distillation column configured for reactive distillation. The crude fatty acid ester product stream 10 is introduced into the distillation column above a reaction zone 20. Reaction zone 20 preferably includes trays (equilibrium stages) which include an etherification catalyst. Suitable catalyst for the etherification includes those previously identified as esterification catalysts.

An alcohol 22, preferably tert-butanol, isobutanol or isoamyl alcohol, can be introduced as a vapor to the bottom of reaction vessel 20 via line 23, and functions similar to the alcohol vapor employed in the esterification reactor.

The alcohol vapor 22 reacts with the glycerin from crude feed 10 to produce glycerin ethers. Vaporous alcohol and water resulting from the etherification reaction exit the reactor via line 24, and is introduced to separator 25. Separator 25 may be any known means for separating water from methanol, such as for example, a distillation column. An alcohol rich stream 26 is supplied form separator 25 to the bottom of the etherification reactor 20 as a vapor. Water exits the separator 25 via line 27.

Product stream 28 exits the reaction vessel 20 as a bottoms stream, preferably including the fatty acid ester product of reaction vessel 5 and a glycerin alkyl ether additive.

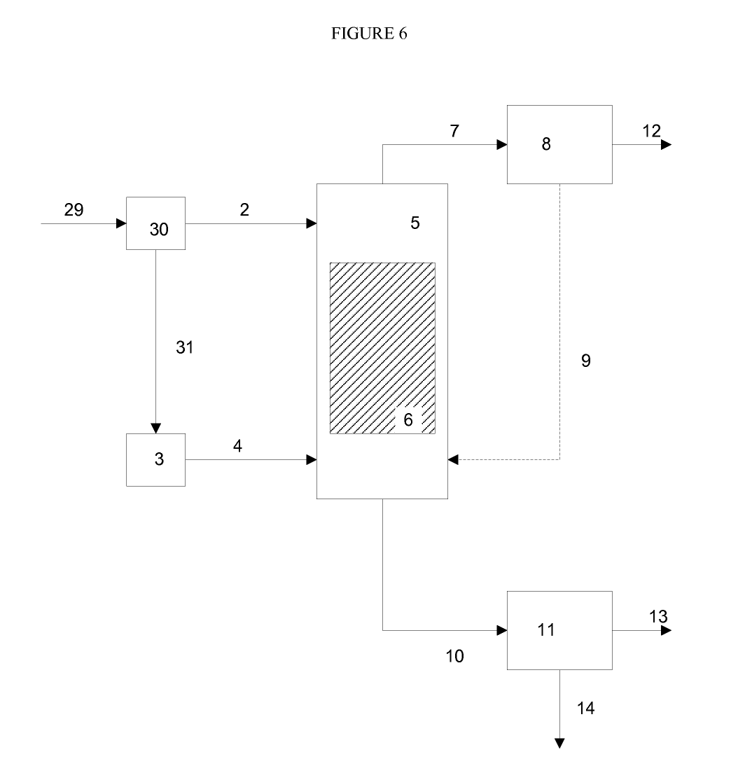

Referring now to FIG. 6, an alternate embodiment for the production of biodiesel fuels is provided. Triglycerides from animal or vegetal oils are supplied via line 29 to a fat splitting unit employing steam to separate triglycerides into component fatty acids and glycerol. The fat splitting unit is known in the art, such as is provided in U.S. Pat. No. 2,486,630 (Brown), incorporated herein by reference. The majority of the glycerin is separated from the fatty acids, and removed from the fatty acid feedstock via line 31. The fatty acid stream from the fat splitter 30 is supplied to the upper portion of the reactive distillation column, preferable above a reaction zone 6. An alcohol 3, preferably methanol, is supplied to the column via line 4.

The reaction zone 6 preferably includes trays or structured packing which includes a heterogeneous catalyst, preferably an ion exchange resin having acidic functional groups. If structured packing is employed, preferably achieving the same vapor-liquid contact as is accomplished with trays. One of skill in the art can determine the equivalent size and type of packing for a given number of trays in a distillation column.

The alcohol is introduced at the bottom of the column as a vapor, traveling upward through the trays, and preferably contacting the fatty acid in the reaction zone in the presence of the appropriate esterification catalyst. Column 5 preferably includes means for heating the alcohol to produce a vapor stream. The alcohol stream exits column 5 via line 7, preferably including at least a portion of the water produced by the esterification reaction.

The alcohol stream can be supplied to an alcohol/water separation unit 8, which separates the stream into a water-rich stream 12 and an alcohol rich stream 9, which can be recycled to the distillation column 5.

Product stream 10 exits the distillation column as the bottoms liquid, and includes fatty acid alkyl ethers and glycerin. The bottoms stream 10 may also include mono-, di- and tri-alkyl ethers of glycerin.

The product stream 10 is supplied to a separation means 11 to remover impurities from product stream 10. The separation means can be any means known in the art for the separation of glycerin and unreacted fatty acids from the product esters, such as for example, using a settling tank for gravity separation. Optionally, the separation means may also include a filter bed (not shown) which includes bauxite, clay or ion exchange resin beads for further purification. The separation means 11 results in a ester-rich stream 13 and a glycerin or fatty acid containing stream 14.

It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment is in accordance with conventional chemical engineering practice. Modifications and variations of the present invention relating to the selection of fatty acid feedstocks, alcohols and catalysts are intended to come within the scope of the invention. All references cited herein are hereby incorporated by reference.

1. A method for obtaining U.S. Federal tax credits under Title 26 Sections 40A and/or 6426 for ester based fuels, and/or a method for obtaining Renewable Identification Numbers under the EPA Clean Air Act as amended by the Energy Independence and Security Act of 2007, comprising:
(A) passing one or more carboxylic acid components and an alcohol component countercurrently through an esterification zone maintained under esterification conditions and containing a solid esterification catalyst selected from particulate ion exchange resins having sulphonic acid groups, carboxylic acid groups or both, wherein
(i) the esterification zone comprises a column reactor provided with a plurality of esterification trays mounted one above another, each adapted to hold a predetermined liquid volume and a charge of particles of a solid esterification catalyst thereon, liquid downcomer means associated with each esterification tray adapted to allow liquid phase to pass down the column reactor from each esterification tray but to retain the particles of solid esterification catalyst thereon, and vapor upcomer means associated with each esterification tray adapted to allow vapor to enter each esterification tray from below and to agitate and maintain the suspension of the mixture of liquid and solid esterification catalyst on that esterification tray, each esterification tray having a floor that slopes towards a zone of turbulence under said vapor upcomer means to prevent formation of stagnant zones of particles of catalyst thereon; and
(ii) the less volatile component of the carboxylic acid component and of the alcohol component is supplied in liquid phase to an upper part of the column reactor above the uppermost esterification tray, while the more volatile component of the carboxylic acid component and of the alcohol component is supplied in vapor form beneath the lowermost one of said plurality of esterification trays; and
(iii) vapor comprising said more volatile component and water of esterification is recovered from an upper part of the column reactor; and
(iv) wherein said carboxylic acid ester is recovered from a lower part of the column reactor;
(B) selling or using as fuel the carboxylic acid ester of step (A)(iv) with or without blending said carboxylic acid ester with taxable fuel;
and
(C) having a tax payer use the product of step (B) as a basis for a claim for U.S. Federal tax credits under Title 26 Sections 40A and/or 6426, and/or for U.S. Federal Renewable Identification Numbers under Environmental Protection Agency Clean Air Act as amended by the Energy Independence and Security Act of 2007.

2. A method according to claim 1, wherein the more volatile component is the alcohol component and the less volatile component is the one or more carboxylic acid components.

3. A method according to claim 1, wherein the alcohol component is an alkanol containing from 1 to about 10 carbon atoms.

4. A method according to claim 3, wherein the alkanol is methanol.

5. A method according to claim 3, wherein the water content of the alkanol vapor supplied to the column reactor is less than about 5 mole %.

6. A method according to claim 1, wherein the carboxylic acid component is an aliphatic monocarboxylic acid or a mixture thereof.

7. A method according to claim 6, wherein the carboxylic acid component is a mixture of fatty acids.

8. A method according to claim 1, wherein the carboxylic acid component contains a mixture of rosin acids.

9. A method according to claim 1, wherein the column reactor is operated at a temperature of from about 80° C. to about 140° C. and at a pressure of from about 1 bar to about 25 bar.

10. A method according to claim 1, wherein the carboxylic acid ester recovered from a lower part of the column reactor is admixed with additional alcohol component and is passed through a fixed bed of a solid esterification catalyst.

11. The method of claim 1, wherein the carboxylic acids are derived from hydrolysis of mono-, di-, or tri-glycerides.

12. The method of claim 1, wherein the carboxylic acids are distilled from a mixture of fatty acids and glycerides.

13. The method of claim 1, wherein the carboxylic acids are produced by the acidulation of soy, palm, canola, rapeseed, jahtropa, or vegetable oil soapstock.

14. The method of claim 1, wherein the carboxylic acids are produced by the acidulation and fractionation of tall oil soaps.

15. The method of claim 1, wherein the carboxylic acids are derived from hydrolysis and distillation of mixtures of fatty acids and triglycerides.
